(19) United States
(12) Patent Application Publication
(10) Pub. No.: US 2011/0153326 A1
(43) Pub. Date: Jun. 23, 2011

(54) SYSTEM AND METHOD FOR COMPUTING AND TRANSMITTING PARAMETERS IN A DISTRIBUTED VOICE RECOGNITION SYSTEM

(75) Inventors: HARINATH GARUDADRI, SAN DIEGO, CA (US); HYNEK HERMANSKY, PORTLAND, OR (US); LUKAS BURGET, HILLSBORO, OR (US); PRATIBHA JAIN, BEAVERTON, OR (US); SACHIN KAJAREKAR, PORTLAND, OR (US); SUNIL SIVADAS, PORTLAND, OR (US); STEPHANE N. DUPONT, SAINT-VAAST (BE); MARIA CARMEN BENITEZ ORTUZAR, GRANADA (ES); NELSON H. MORGAN, OAKLAND, CA (US)

(73) Assignee: QUALCOMM INCORPORATED, San Diego, CA (US)

(21) Appl. No.: 13/024,135

(22) Filed: Feb. 9, 2011

Related U.S. Application Data
(63) Continuation of application No. 10/059,737, filed on Jan. 28, 2002.
(60) Provisional application No. 60/265,769, filed on Jan. 31, 2001.
(60) Provisional application No. 60/265,263, filed on Jan. 30, 2001.

(51) Int. Cl. G10L 15/00

(52) U.S. Cl. 704/240; 704/E15.001

(57) ABSTRACT

A system and method for extracting acoustic features and speech activity on a device and transmitting them in a distributed voice recognition system. The distributed voice recognition system includes a local VR engine in a subscriber unit and a server VR engine on a server. The local VR engine comprises a feature extraction (FE) module that extracts features from a speech signal, and a voice activity detection module (VAD) that detects voice activity within a speech signal. The system includes filters, framing and windowing modules, power spectrum analyzers, a neural network, a nonlinear element, and other components to selectively provide an advanced front end vector including predetermined portions of the voice activity detection indication and extracted features from the subscriber unit to the server. The system also includes a module to generate additional feature vectors on the server from the received features using a feed-forward multilayer perceptron (MLP) and providing the same to the speech server.

### CROSS REFERENCE

The present Application for Patent is a continuation of patent application Ser. No. 10/059,737 entitled “SYSTEM AND METHOD FOR COMPUTING AND TRANSMITTING PARAMETERS IN A DISTRIBUTED VOICE RECOGNITION SYSTEM” filed Jan. 28, 2002, pending, which claims priority to Provisional Application No. 60/265,769, filed Jan. 31, 2001, entitled “Method for Extracting Terminal Features In A Distributed Voice Recognition System,” and Provisional Application No. 60/265,263, filed Jan. 30, 2001, entitled “Method for Extracting Front End Features In A Distributed Voice Recognition System,” both currently assigned to the assignee of the present invention.

### BACKGROUND

1. Field

The present invention relates generally to the field of communications and more specifically to transmitting speech activity in a distributed voice recognition system.

2. Background

Voice recognition (VR) represents an important technique enabling a machine with simulated intelligence to recognize user-voiced commands and to facilitate a human interface with the machine. VR also represents a key technique for human speech understanding. Systems employing techniques to recover a linguistic message from an acoustic speech signal are called voice recognizers.

VR, also known as speech recognition, provides certain safety benefits to the public. For example, VR may be employed to replace the manual task of pushing buttons on a wireless keypad, a particularly useful replacement when the operator is using a wireless handset while driving an automobile. When a user employs a wireless telephone without VR capability, the driver must remove his or her hand from the steering wheel and look at the telephone keypad while pushing buttons to dial the call. Such actions tend to increase the probability of an automobile accident. A speech-enabled automobile telephone, or telephone designed for speech recognition, enables the driver to place telephone calls while continuously monitoring the road. In addition, a hands-free automobile wireless telephone system allows the driver to hold both hands on the steering wheel while initiating a phone call. A sample vocabulary for a simple hands-free automobile wireless telephone kit might include the 10 digits, the keywords “call,” “send,” “dial” “cancel,” “clear,” “add,” “delete,” history,” “program,” “yes,” and “no,” and the names of a predefined number of commonly called co-workers, friends, or family members.

A voice recognizer, or VR system, comprises an acoustic processor, also called the front end of a voice recognizer, and a word decoder, also called the back end of the voice recognizer. The acoustic processor performs feature extraction for the system by extracting a sequence of information bearing features, or vectors, necessary for performing voice recognition on the incoming raw speech. The word decoder subsequently decodes the sequence of features, or vectors, to provide a meaningful and desired output, such as the sequence of linguistic words corresponding to the received input utterance.

In a voice recognizer implementation using a distributed system architecture, it is often desirable to place the word decoding task on a subsystem having the ability to appropriately manage computational and memory load, such as a network server. The acoustic processor should physically reside as close to the speech source as possible to reduce adverse effects associated with vocoders. Vocoders compress speech prior to transmission, and can in certain circumstances introduce adverse characteristics due to signal processing and/or channel induced errors. These effects typically result from vocoding at the user device. The advantage to a Distributed Voice Recognition (DVR) system is that the acoustic processor resides in the user device and the word decoder resides remotely, such as on a network, thereby decreasing the risk of user device signal processing errors or channel errors.

DVR systems enable devices such as cell phones, personal communications devices, personal digital assistants (PDAs), and other devices to access information and services from a wireless network, such as the Internet, using spoken commands. These devices access voice recognition servers on the network and are much more versatile, robust and useful than systems recognizing only limited vocabulary sets.

In wireless applications, air interface methods degrade the overall accuracy of the voice recognition systems. This degradation can in certain circumstances be mitigated by extracting VR features from a user's spoken commands. Extraction occurs on a device, such as a subscriber unit, also called a subscriber station, mobile station, mobile, remote station, remote terminal, access terminal, or user equipment. The subscriber unit can transmit the VR features in data traffic, rather than transmitting spoken words in voice traffic.

Thus, in a DVR system, front end features are extracted at the device and are sent to the network. A device may be mobile or stationary, and may communicate with one or more base stations (BSes), also called cellular base stations, cell base stations, base transceiver system (BTSes), base station transceivers, central communication centers, access points, access nodes, Node Bs, and modem pool transceivers (MPTs).

Complex voice recognition tasks require significant computational resources. Such systems cannot practically reside on a subscriber unit having limited CPU, battery, and memory resources. Distributed systems leverage the computational resources available on the network. In a typical DVR system, the word decoder has significantly higher computational and memory requirements than the front end of the voice recognizer. Thus a server based voice recognition system within the network serves as the backend of the voice recognition system and performs word decoding. Using the server based VR system as the backend provides the benefit of performing complex VR tasks using network resources rather than user device resources. Examples of DVR systems are disclosed in U.S. Pat. No. 5,956,683, entitled “Distributed Voice Recognition System,” assigned to the assignee of the present invention and incorporated by reference herein.

The subscriber may perform simple VR tasks in addition to the feature extraction function. Performance of these functions at the user terminal frees the network of the need to engage in simple VR tasks, thereby reducing network traffic and the associated cost of providing speech enabled services. In certain circumstances, traffic congestion on the network can result in poor service for subscriber units from the server based VR system. A distributed VR system enables rich user interface features using complex VR tasks, with the downside of increased network traffic and occasional delay. If a local VR engine on the subscriber unit fails to recognize a user's spoken commands, the user's spoken commands must be transmitted to the server based VR engine after front end processing, thereby increasing network traffic and network congestion. Network congestion occurs when a significant quantity of network traffic is concurrently transmitted from subscriber units to the server based VR system. After the network based VR engine interprets the spoken commands, the results must be transmitted back to the subscriber unit, which can introduce system delays if network congestion is present.

In a DVR system, a need exists to extract robust acoustic features and transmit them with minimal delay over the network.

### SUMMARY

The aspects described herein are directed to a system and method for computing robust acoustic features and speech activity on a device and further transmitting these to a device on a network. A system and method for transmitting speech activity for voice recognition includes a Voice Activity Detection (VAD) module and a Feature Extraction (FE) module on the subscriber unit.

In one aspect, a system for processing and transmitting speech information comprises a feature extraction module configured to extract at least one feature from a speech signal, a voice activity detection module configured to detect voice activity within the speech signal and provide an indication of detected voice activity, and a transmitter configured to selectively transmit aspects associated with the indication of detected voice activity from the voice activity detection module and the at least one feature from the feature extraction module.

In another aspect, a system for processing speech comprises a terminal feature extraction submodule for extracting at least one feature from the speech, and a terminal compression module for distinguishing the presence of voice activity from silence in the speech to determine voice activity data, compressing the at least one feature, and selectively combining and transmitting the at least one feature with selected voice activity data.

In another aspect, a distributed voice recognition system for transmitting speech activity comprises a subscriber unit, comprising a processing/feature extraction element receiving speech activity and converting the speech activity into features, a voice activity detector for detecting voice activity within the speech and providing at least one voice activity indication, and a processor for selectively combining the features with the at least one voice activity indication into advanced front end features, and a transmitter for transmitting the advanced front end features to a remote device.

In still another aspect, a subscriber unit comprises a feature extraction module configured to extract a plurality of features of a speech signal, a voice activity detection module configured to detect voice activity within the speech signal and provides an indication of the detected voice activity, and a processor/transmitter coupled to the feature extraction module and the voice activity detection module and configured to selectively receive detected voice activity and the plurality of features and transmit a set of at least one advanced front end feature.

In yet another aspect, a subscriber unit comprises means for extracting a plurality of features of a speech signal, means for detecting voice activity with the speech signal and providing an indication of the detected voice activity, and a transmitter coupled to the feature extraction means and the voice activity detection means and configured to selectively transmit indication of detected voice activity in selective combination with the plurality of features to a remote device.

In another aspect, a method of transmitting speech activity comprises extracting a plurality of features of a speech signal, detecting voice activity within the speech signal and providing an indication of the detected voice activity, and selectively transmitting the indication of detected voice activity in selective combination with the plurality of features.

In another aspect, a method of transmitting speech activity comprises extracting a plurality of features of a speech signal, detecting voice activity with the speech signal and providing an indication of the detected voice activity, and selectively combining the plurality of features with an indication of the detected voice activity, thereby creating an advanced front end combined indication of detected voice activity and features.

In another aspect, a method of detecting voice activity comprises receiving nonlinearly transformed filtered spectral data, performing a discrete cosine transformation of the nonlinearly transformed filtered data, providing an estimate of a probability of a current frame being speech based on said discrete cosine transformation, applying a threshold to the estimate, and providing the option of combining the result of said applying to a feature extraction function.

In another aspect, a system for detecting speech activity comprises a processor for generating filtered spectral data, a voice activity detector receiving said filtered spectral data and generating an indication of detected voice activity, and a feature extraction module for extracting a plurality of features of a speech signal based on said filtered spectral data, and a transmitter, wherein the system employs at least one of the voice activity detector and feature extraction module to form an advanced front end feature vector and provide the advanced front end feature vector to the transmitter.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 shows a voice recognition system including an Acoustic Processor and a Word Decoder in accordance with one aspect;

FIG. 2 shows an exemplary aspect of a distributed voice recognition system;

FIG. 3 illustrates delays in an exemplary aspect of a distributed voice recognition system;

FIG. 4 shows a block diagram of a VAD module in accordance with one aspect;

FIG. 5 shows a block diagram of a VAD submodule in accordance with one aspect;

FIG. 6 shows a block diagram of a combined VAD submodule and FE module in accordance with one aspect;

FIG. 7 shows a VAD module state diagram in accordance with one aspect;

FIG. 8 shows parts of speech and VAD events on a timeline in accordance with one aspect;

FIG. 9 an overall system block diagram including terminal and server components;

FIG. 10 shows frame information for the mth frame;

FIG. 11 is the CRC protected packet stream; and

FIG. 12 shows server feature vector generation.

### DETAILED DESCRIPTION

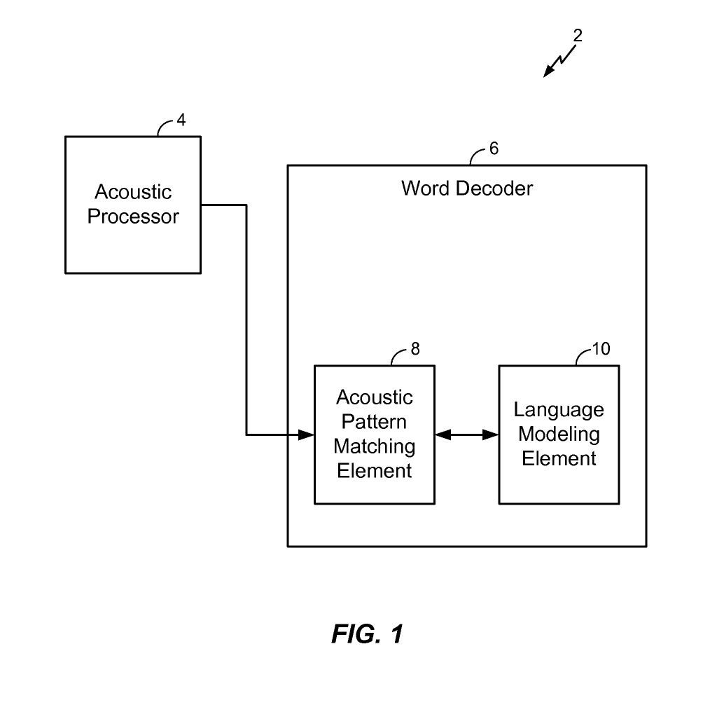

FIG. 1 illustrates a voice recognition system 2 including an acoustic processor 4 and a word decoder 6 in accordance with one aspect of the current system. The word decoder 6 includes an acoustic pattern matching element 8 and a language modeling element 10. The language modeling element 10 is also known by some in the art as a grammar specification element. The acoustic processor 4 is coupled to the acoustic matching element 8 of the word decoder 6. The acoustic pattern matching element 8 is coupled to a language modeling element 10.

The acoustic processor 4 extracts features from an input speech signal and provides those features to word decoder 6. In general, the word decoder 6 translates the acoustic features received from the acoustic processor 4 into an estimate of the speaker's original word string. The estimate is created via acoustic pattern matching and language modeling. Language modeling may be omitted in certain situations, such as applications of isolated word recognition. The acoustic pattern matching element 8 detects and classifies possible acoustic patterns, such as phonemes, syllables, words, and so forth. The acoustic pattern matching element 8 provides candidate patterns to language modeling element 10, which models syntactic constraint rules to determine gramatically well formed and meaningful word sequences. Syntactic information can be employed in voice recognition when acoustic information alone is ambiguous. The voice recognition system sequentially interprets acoustic feature matching results and provides the estimated word string based on language modeling.

Both the acoustic pattern matching and language modeling in the word decoder 6 require deterministic or stochastic modeling to describe the speaker's phonological and acoustic-phonetic variations. Speech recognition system performance is related to the quality of pattern matching and language modeling. Two commonly used models for acoustic pattern matching known by those skilled in the art are template-based dynamic time warping (DTW) and stochastic hidden Markov modeling (HMM).

The acoustic processor 4 represents a front end speech analysis subsystem of the voice recognizer 2. In response to an input speech signal, the acoustic processor 4 provides an appropriate representation to characterize the time varying speech signal. The acoustic processor 4 may discard irrelevant information such as background noise, channel distortion, speaker characteristics, and manner of speaking. The acoustic feature may furnish voice recognizers with higher acoustic discrimination power. In this aspect of the invention, the short time spectral envelope is a highly useful characteristic. In characterizing the short time spectral envelope, a commonly used spectral analysis technique is filter-bank based spectral analysis.

Combining multiple VR systems, or VR engines, provides enhanced accuracy and uses a greater amount of information from the input speech signal than a single VR system. One system for combining VR engines is described in U.S. patent application Ser. No. 09/618,177, entitled “Combined Engine System and Method for Voice Recognition,” filed Jul. 18, 2000, and U.S. patent application Ser. No. 09/657,760, entitled “System and Method for Automatic Voice Recognition Using Mapping,” filed Sep. 8, 2000, assigned to the assignee of the present application and fully incorporated herein by reference.

In one aspect of the present system, multiple VR engines are combined into a distributed VR system. The multiple VR engines provide a VR engine at both the subscriber unit and the network server. The VR engine on the subscriber unit is called the local VR engine, while the VR engine on the server is called the network VR engine. The local VR engine comprises a processor for executing the local VR engine and a memory for storing speech information. The network VR engine comprises a processor for executing the network VR engine and a memory for storing speech information.

One example of a distributed VR system is disclosed in U.S. patent application Ser. No. 09/755,651, entitled “System and Method for Improving Voice Recognition in a Distributed Voice Recognition System,” filed Jan. 5, 2001, assigned to the assignee of the present invention and incorporated by reference herein.

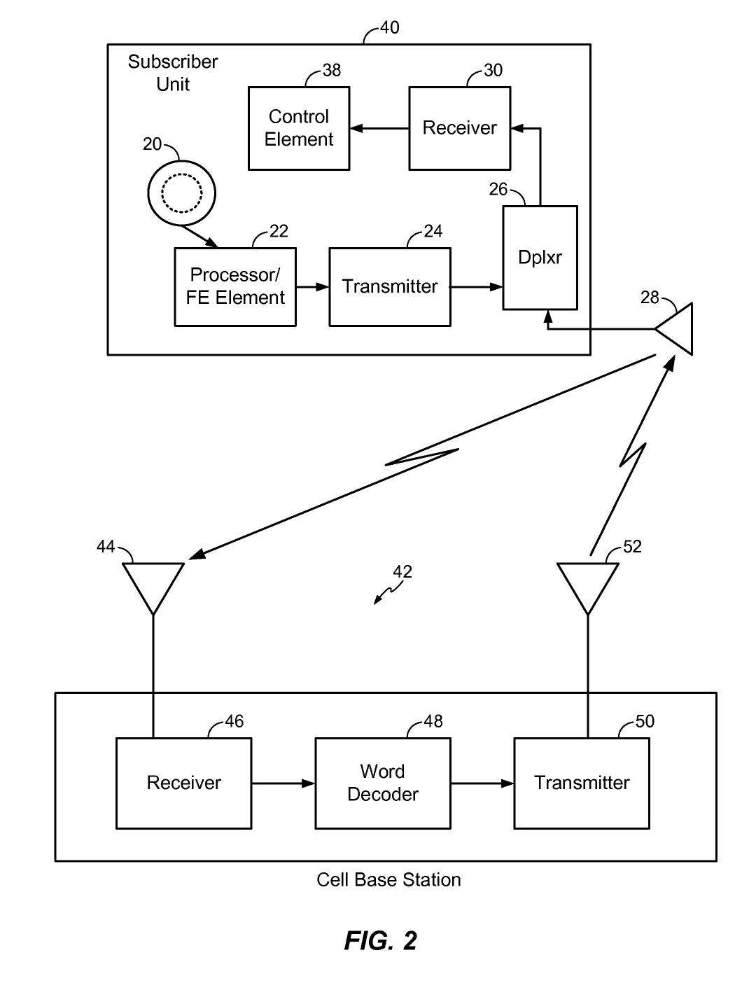

FIG. 2 shows one aspect of the present invention. In FIG. 2, the environment is a wireless communication system comprising a subscriber unit 40 and a central communications center known as a cell base station 42. In this aspect, the distributed VR includes an acoustic processor or feature extraction element 22 residing in a subscriber unit 40 and a word decoder 48 residing in the central communications center. Because of the high computation costs associated with voice recognition implemented solely on a subscriber unit, voice recognition in a non-distributed voice recognition system for even a medium size vocabulary would be highly infeasible. If VR resides solely at the base station or on a remote network, accuracy may be decreased dramatically due to degradation of speech signals associated with speech codec and channel effects. Advantages for a distributed system include reduction in cost of the subscriber unit resulting from the absence of word decoder hardware, and reduction of subscriber unit battery drain associated with local performance of the computationally intensive word decoder operation. A distributed system improves recognition accuracy in addition to providing flexibility and extensibility of the voice recognition functionality.

Speech is provided to microphone 20, which converts the speech signal into electrical signals and provided to feature extraction element 22. Signals from microphone 20 may be analog or digital. If analog, an A/D converter (not shown) may be interposed between microphone 20 and feature extraction element 22. Speech signals are provided to feature extraction element 22, which extracts relevant characteristics of the input speech used to decode the linguistic interpretation of the input speech. One example of characteristics used to estimate speech is the frequency characteristics of an input speech frame. Input speech frame characteristics are frequently employed as linear predictive coding parameters of the input speech frame. The extracted speech features are then provided to transmitter 24 which codes, modulates, and amplifies the extracted feature signal and provides the features through duplexer 26 to antenna 28, where the speech features are transmitted to cellular base station or central communications center 42. Various types of digital coding, modulation, and transmission schemes known in the art may be employed by the transmitter 24.

At central communications center 42, the transmitted features are received at antenna 44 and provided to receiver 46. Receiver 46 may perform the functions of demodulating and decoding received transmitted features, and receiver 46 provides these features to word decoder 48. Word decoder 48 determines a linguistic estimate of the speech from the speech features and provides an action signal to transmitter 50. Transmitter 50 amplifies, modulates, and codes the action signal, and provides the amplified signal to antenna 52. Antenna 52 transmits the estimated words or a command signal to portable phone 40. Transmitter 50 may also employ digital coding, modulation, or transmission techniques known in the art.

At subscriber unit 40, the estimated words or command signals are received at antenna 28, which provides the received signal through duplexer 26 to receiver 30 which demodulates and decodes the signal and provides command signal or estimated words to control element 38. In response to the received command signal or estimated words, control element 38 provides the intended response, such as dialing a phone number, providing information to a display screen on the portable phone, and so forth.

In one aspect of the present invention, the information sent from central communications center 42 need not be an interpretation of the transmitted speech, but may instead be a response to the decoded message sent by the portable phone. For example, one may inquire about messages on a remote answering machine coupled via a communications network to central communications center 42, in which case the signal transmitted from the central communications center 42 to subscriber unit 40 may be the messages from the answering machine. A second control element for controlling the data, such as the answering machine messages, may also be located in the central communications center.

A VR engine obtains speech data in the form of Pulse Code Modulation, or PCM, signals. The VR engine processes the signal until a valid recognition is made or the user has stopped speaking and all speech has been processed. In one aspect, the DVR architecture includes a local VR engine that obtains PCM data and transmits front end information. The front end information may include cepstral parameters, or may be any type of information or features that characterize the input speech signal. Any type of features known in the art could be used to characterize the input speech signal.

For a typical recognition task, the local VR engine obtains a set of trained templates from its memory. The local VR engine obtains a grammar specification from an application. An application is service logic that enables users to accomplish a task using the subscriber unit. This logic is executed by a processor on the subscriber unit. It is a component of a user interface module in the subscriber unit.

A system and method for improving storage of templates in a voice recognition system is described in U.S. patent application Ser. No. 09/760,076, entitled “System And Method For Efficient Storage Of Voice Recognition Models”, filed Jan. 12, 2001, which is assigned to the assignee of the present invention and fully incorporated herein by reference. A system and method for improving voice recognition in noisy environments and frequency mismatch conditions and improving storage of templates is described in U.S. patent application Ser. No. 09/703,191, entitled “System and Method for Improving Voice Recognition In Noisy Environments and Frequency Mismatch Conditions”, filed Oct. 30, 2000, which is assigned to the assignee of the present invention and fully incorporated herein by reference.

A “grammar” specifies the active vocabulary using sub-word models. Typical grammars include 7-digit phone numbers, dollar amounts, and a name of a city from a set of names. Typical grammar specifications include an “Out of Vocabulary (OOV)” condition to represent the situation where a confident recognition decision could not be made based on the input speech signal.

In one aspect, the local VR engine generates a recognition hypothesis locally if it can handle the VR task specified by the grammar The local VR engine transmits front-end data to the VR server when the grammar specified is too complex to be processed by the local VR engine.

As used herein, a forward link refers to transmission from the network server to a subscriber unit and a reverse link refers to transmission from the subscriber unit to the network server. Transmission time is partitioned into time units. In one aspect of the present system, the transmission time may be partitioned into frames. In another aspect, the transmission time may be partitioned into time slots. In accordance with one aspect, the system partitions data into data packets and transmits each data packet over one or more time units. At each time unit, the base station can direct data transmission to any subscriber unit, which is in communication with the base station. In one aspect, frames may be further partitioned into a plurality of time slots. In yet another aspect, time slots may be further partitioned, such as into half-slots and quarter-slots.

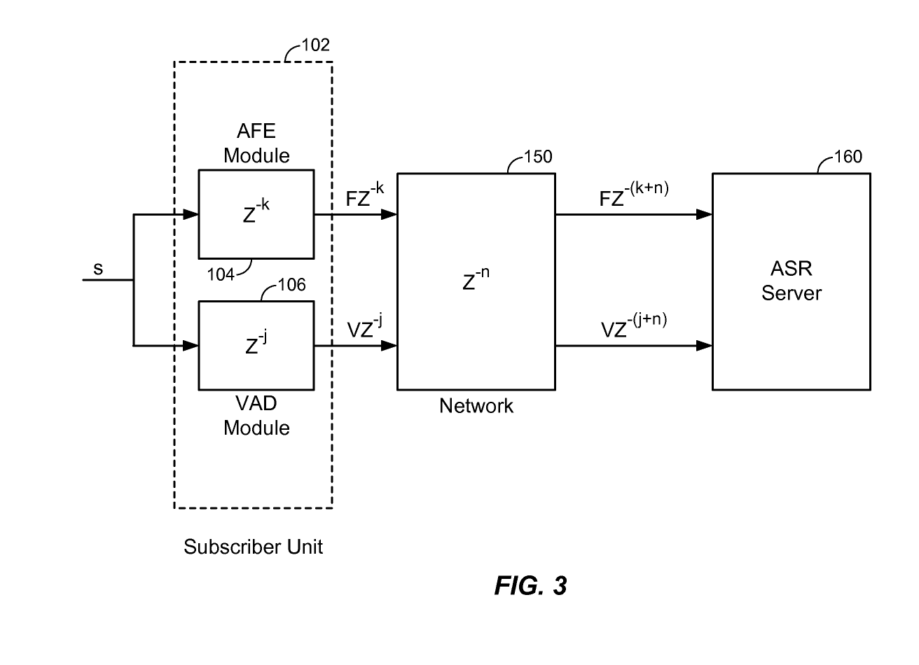

FIG. 3 illustrates delays in an exemplary aspect of a distributed voice recognition system 100. The DVR system 100 comprises a subscriber unit 102, a network 150, and a speech recognition (SR) server 160. The subscriber unit 102 is coupled to the network 150 and the network 150 is coupled to the SR server 160. The front-end of the DVR system 100 is the subscriber unit 102, which comprises a feature extraction (FE) module 104 and a voice activity detection (VAD) module 106. The FE performs feature extraction from a speech signal and compression of resulting features. In one aspect, the VAD module 106 determines which frames will be transmitted from a subscriber unit to an SR server. The VAD module 106 divides the input speech into segments comprising frames where speech is detected and the adjacent frames before and after the frame with detected speech. In one aspect, an end of each segment (EOS) is marked in a payload by sending a null frame.

The VR front end performs front end processing in order to characterize a speech segment. Vector S is a speech signal and vector F and vector V are FE and VAD vectors, respectively. In one aspect, the VAD vector is one element long and the one element contains a binary value. In another aspect, the VAD vector is a binary value concatenated with additional features. In one aspect, the additional features are band energies enabling server fine end-pointing. End-pointing constitutes demarcation of a speech signal into silence and speech segments. Use of band energies to enable server fine end-pointing allows use of additional computational resources to arrive at a more reliable VAD decision.

Band energies correspond to bark amplitudes. The Bark scale is a warped frequency scale of critical bands corresponding to human perception of hearing. Bark amplitude calculation is known in the art and described in Lawrence Rabiner & Biing-Hwang Juang, Fundamentals of Speech Recognition (1993), which is fully incorporated herein by reference. In one aspect, digitized PCM speech signals are converted to band energies.

FIG. 3 illustrates delays in an exemplary aspect of a distributed voice recognition system. The delays in computing vectors F and V and transmitting them over the network are shown using Z transform notation. The algorithm latency introduced in computing vector F is k, and in one aspect, the range of k is from 100 to 300 msec. Similarly, the algorithm latency for computing VAD information is j and in one aspect, the range of j is from 10 to 100 msec. Thus, FE feature vectors are available with a delay of k units and VAD information is available with a delay of j units. The delay introduced in transmitting the information over the network is n units. The network delay is the same for both vectors F and V.

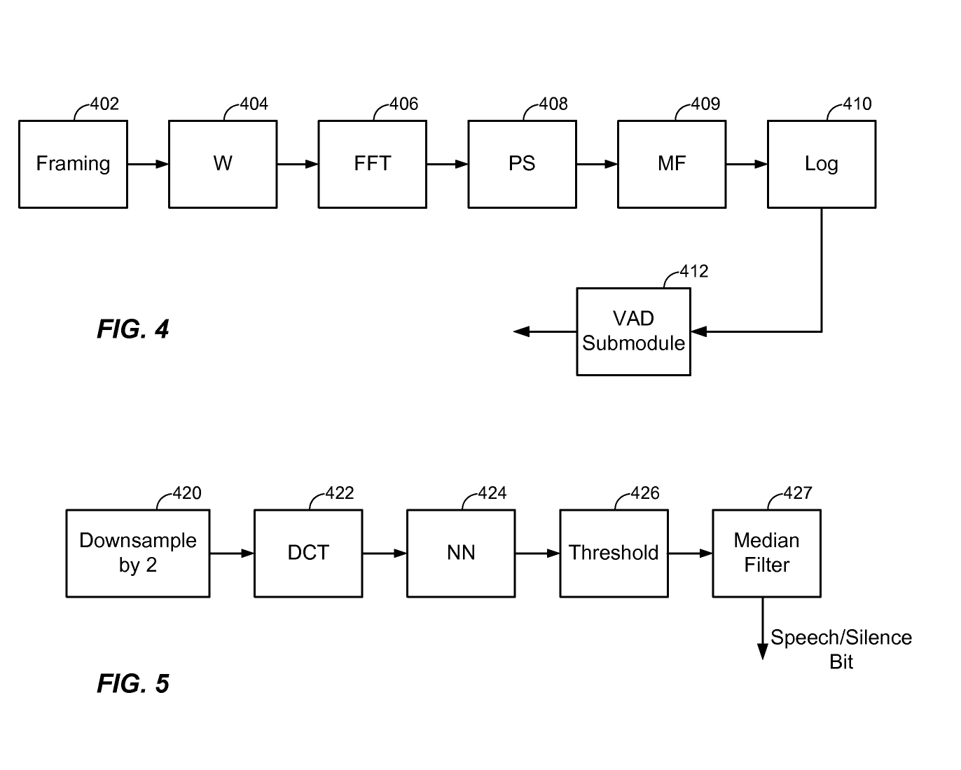

FIG. 4 illustrates a block diagram of the VAD module 400. The framing module 402 includes an analog-to-digital converter (not shown). In one aspect, the output speech sampling rate of the analog-to-digital converter is 8 kHz. It would be understood by those skilled in the art that other output sampling rates can be used. The speech samples are divided into overlapping frames. In one aspect, the frame length is 25 ms (200 samples) and the frame rate is 10 ms (80 samples).

In one aspect of the current system, each frame is windowed by a windowing module 404 using a Hamming window function.

$${s}_{w} ( n ) = \{ 0.54 - 0.46 \cdot cos ( \frac{2 π ( n - 1 )}{N - 1} ) \} \cdot s ( n ) , \\ 1 \leq n \leq N$$

where N is the frame length and s(n) and s_{w}(n) are the input and output of the windowing block, respectively.

A fast Fourier transform (FFT) module 406 computes a magnitude spectrum for each windowed frame. In one aspect, the system uses a fast Fourier transform of length 256 to compute the magnitude spectrum for each windowed frame. The first 129 bins from the magnitude spectrum may be retained for further processing. Fast fourier transformation takes place according to the following equation:

$${bin}_{k} = \vert {\sum }_{n = 0}^{FFTL - 1} {s}_{w} ( n ) {e}^{- j n k \frac{2 π}{FFTL}} \vert , \\ k = 0 , … , FFTL - 1.$$

where s_{w}(n) is the input to the FFT module 406, FFTL is the block length (256), and binₖ is the absolute value of the resulting complex vector. The power spectrum (PS) module 408 computes a power spectrum by taking the square of the magnitude spectrum.

In one aspect, a Mel-filtering module 409 computes a MEL-warped spectrum using a complete frequency range [0-4000 Hz]. This band is divided into 23 channels equidistant in MEL frequency scale, providing 23 energy values per frame. In this aspect, Mel-filtering corresponds to the following equations:

$$Mel \{ x \} = 2595 * {log}_{10} ( 1 + \frac{x}{700} ) , \\ {f}_{{c}_{i}} = {Mel}^{- 1} \{ i * Mel \{ \frac{{f}_{s} / 2}{23 + 1} \} \} , i = 1 , … , 23$$

$$cbin = floor \{ \frac{{f}_{{c}_{i}}}{{f}_{s}} * FFTL \}$$

where floor(.) stands for rounding down to the nearest integer. The output of the MEL filter is the weighted sum of the FFT power spectrum values, binᵢ in each band. Triangular, half overlapped windowing may be employed according to the following equation:

$${fbank}_{k} = {\sum }_{j = {cbin}_{k - 1}}^{{cbin}_{k}} \frac{j - {cbin}_{k - 1}}{{cbin}_{k} - {cbin}_{k - 1}} {bin}_{i} + {\sum }_{{cbin}_{i}}^{{cbin}_{i + 1}} \frac{{cbin}_{k + 1} - j}{{cbin}_{k + 1} - {cbin}_{k}} ,$$

where k=1, . . . , 23. chin₀ and cbin₂₄ denote FFT bin indices corresponding to the starting frequency and half of the sampling frequency, respectively:

$${cbin}_{0} = 0$$

$${cbin}_{24} = floor \{ \frac{{f}_{s} / 2}{{f}_{s}} * FFTL \} = FFTL / 2$$

It would be understood by those skilled in the art that alternate MEL-filtering equations and parameters may be employed depending on the circumstances. Warping the frequency axis with a Bark Scale in place of a MEL scale is one such example.

The output of the Mel-filtering module 409 is the weighted sum of FFT power spectrum values in each band. The output of the Mel-filtering module 409 passes through a logarithm module 410 that performs non-linear transformation of the Mel-filtering output. In one aspect, the non-linear transformation is a natural logarithm. It would be understood by those skilled in the art that other non-linear transformations could be used.

A Voice Activity Detector (VAD) sub-module 412 takes as input the transformed output of the logarithm module 409 and discriminates between speech and non-speech frames. As shown in FIG. 4, the transformed output of the logarithm module may be directly transmitted rather than passed to the VAD submodule 412. Bypassing the VAD submodule 412 occurs when Voice Activity Detection is not required, such as when no frames of data are present. The VAD sub-module 412 detects the presence of voice activity within a frame. The VAD sub-module 412 determines whether a frame has voice activity or has no voice activity. In one aspect, the VAD sub-module 412 is a three layer Feed-Forward Neural Net. The Feed-Forward Neural Net may be trained to discriminate between speech and non-speech frames using Backpropagation algorithm. The system performs training offline using noisy databases such as the training part of Aurora2-TIDigits and SpeechDatCar-Italian, artificially corrupted TIMIT and Speech in Noise Environment (SPINE) databases.

FIG. 5 shows a block diagram of a VAD sub-module 500. In one aspect, a downsample module 420 downsamples the output of the logarithm module by a factor of two.

A Discrete Cosine Transform (DCT) module 422 calculates cepstral coefficients from the downsampled 23 logarithmic energies on the MEL scale. In one aspect, the DCT module 422 calculates 15 cepstral coefficients.

A neural net (NN) module 424 provides an estimate of the posterior probability of the current frame being speech or non-speech. A threshold module 426 applies a threshold to the estimate from the NN module 424 in order to convert the estimate to a binary feature. In one aspect, the system uses a threshold of 0.5.

A Median Filter module 427 smoothes the binary feature. In one aspect, the binary feature is smoothed using an 11-point median filter. In one aspect, the Median Filter module 427 removes any short pauses or short bursts of speech of duration less than 40 ms. In one aspect, the Median Filter module 427 also adds seven frames before and after the transition from silence to speech. In one aspect, the system sets a bit according to whether a frame is determined to be speech activity or silence.

The neural net module 424 and median filter module 427 may operate as follows. The Neural Net module 424 has six input units, fifteen hidden units and one output. Input to the Neural Net module 424 may consist of three frames, current frame and two adjacent frames, of two cepstral coefficients, C0 and C1, derived from the log-Mel-filterbank energies. As the three frames used are after downsampling, they effectively represent five frames of information. During training, neural net module 424 has two outputs, one each for speech and non-speech targets. Output of the trained neural net module 424 may provide an estimate of the posterior probability of the current frame being speech or non-speech. During testing under normal conditions only the output corresponding to the posterior probability of non-speech is used. A threshold of 0.5 may be applied to the output to convert it to a binary feature. The binary feature may be smoothed using an eleven point median filter corresponding to median filter module 427. Any short pauses or short bursts of speech of duration less than approximately 40 ms are removed by this filtering. The filtering also adds seven frames before and after the transition from silence to speech and speech to silence to detected respectively. Although the eleven point median filter, five frames in the past and five frames ahead, causes a delay of ten frames, or about 100 ms. This delay is the result of downsampling and is absorbed into the 200 ms delay caused by the subsequent LDA filtering.

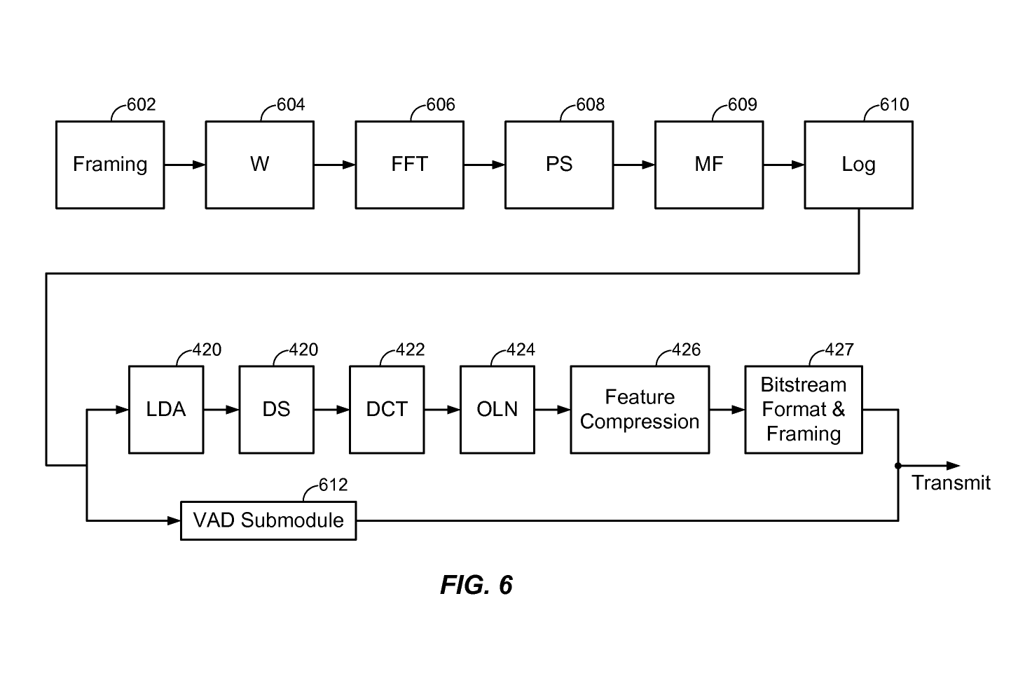

FIG. 6 shows a block diagram of the FE module 600. A framing module 602, windowing module 604, FFT module 606, PS module 608, MF module 609, and a logarithm module 610, are also part of the FE and serve the same functions in the FE module 600 as they do in the VAD module 400. In one aspect, these common modules are shared between the VAD module 400 and the FE module 600.

A VAD sub-module 612 is coupled to the logarithm module 610. A Linear Discriminant Analysis (LDA) module 428 is coupled to the VAD sub-module 612 and applies an anti-aliasing bandpass filter to the output of the VAD sub-module 610. In one aspect, the bandpass filter is a RASTA filter. An exemplary bandpass filter that can be used in the VR front end is the RASTA filter described in U.S. Pat. No. 5,450,522 entitled, “Auditory Model for Parametrization of Speech” filed Sep. 12, 1995, which is incorporated by reference herein. As employed herein, the system may filter the time trajectory of log energies for each of the 23 channels using a 41-tap FIR filter. The filter coefficients may be those derived using the linear discriminant analysis (LDA) technique on the phonetically labeled OGI-Stories database known in the art. Two filters may be retained to reduce the memory requirement. These two filters may be further approximated using 41 tap symmetric FIR filters. The filter with 6 Hz cutoff is applied to Mel channels 1 and 2, and the filter with 16 Hz cutoff is applied to channels 3 to 23. The output of the filters is the weighted sum of the time trajectory centered around the current frame, the weighting being given by the filter coefficients. This temporal filtering assumes a look-ahead of approximately 20 frames, or approximately 200 ms. Again, those skilled in the art may use different computations and coefficients depending on circumstances and desired performance. One skilled in the art understands that the anti-aliasing filter can be omitted under certain circumstances, e.g., the signal from the preceding module is band limited, the alias is removed in later modules, and other circumstances known to one skilled in the art.

A downsample module 430 downsamples the output of the LDA module. In one aspect, a downsample module 430 downsamples the output of the LDA module by a factor of two. Time trajectories of the 23 Mel channels may be filtered only every second frame.

A Discrete Cosine Transform (DCT) module 432 calculates cepstral coefficients from the downsampled 23 logarithmic energies on the MEL scale. In one aspect, the DCT module 432 calculates 15 cepstral coefficients according to the following equation:

$${C}_{i} = \frac{{\sum }_{j = 1}^{23} {f}_{i} * cos ( \frac{π \cdot i}{23} \cdot ( j - 0.5 ) )}{\sqrt{{\sum }_{j = 1}^{23} cos ( \frac{π \cdot i}{23} \cdot ( j - 0.5 ) ) * cos ( \frac{π \cdot i}{23} \cdot ( j - 0.5 ) )}} , 0 \leq i \leq 14$$

In order to compensate for the noises, an online normalization (OLN) module 434 applies a mean and variance normalization to the cepstral coefficients from the DCT module 432. The estimates of the local mean and variance are updated for each frame. In one aspect, an experimentally determined bias is added to the estimates of the variance before normalizing the features. The bias eliminates the effects of small noisy estimates of the variance in the long silence regions. Dynamic features are derived from the normalized static features. The bias not only saves computation required for normalization but also provides better recognition performance. Normalization may employ the following equations:

$${m}_{t} = {m}_{t - 1} - α ( {x}_{t} - {m}_{t - 1} ) . \\ {σ}_{t}^{2} = {σ}_{t - 1}^{2} - α ⌊ {( {x}_{t} - {m}_{t} )}^{2} - {σ}_{t - 1}^{2} ⌋$$

$${x}_{t}^{′} = \frac{( {x}_{t} - {m}_{t} )}{{σ}_{t} + θ}$$

where xₜ is the cepstral coefficient at time t, mₜ and σₜ² are the mean and the variance of the cepstral coefficient estimated at time t, and x′ₜ is the normalized cepstral coefficient at time t. The value of α may be less than one to provide positive estimate of the variance. The value of α may be 0.1 and the bias, θ may be fixed at 1.0. The final feature vector may include 15 cepstral coefficients, including C0. These 15 cepstral coefficients constitute the front end output.

A feature compression module 436 compresses the feature vectors. A bit stream formatting and framing module 438 performs bitstream formatting of the compressed feature vectors, thereby preparing them for transmission. In one aspect, the feature compression module 436 performs error protection of the formatted bit stream.

The FE module 600 concatenates vector F Z^{-k} and vector V Z^{-j}. Thus, each FE feature vector is comprised of a concatenation of vector F Z^{-k} and vector V Z^{-j}.

In the present invention, the system transmits VAD output ahead of a payload, which reduces a DVR system's overall latency since the front end processing of the VAD is shorter (j<k) than the FE front end processing. In one aspect, an application running on the server can determine the end of a users utterance when vector V indicates silence for more than an S_{hangover} period of time. S_{hangover} is the period of silence following active speech for utterance capture to be complete. S_{hangover} is typically greater than an embedded silence allowed in an utterance. If S_{hangover}>k, FE algorithm latency will not increase the response time. FE features corresponding to time t-k and VAD features corresponding to time t-j may be combined to form extended FE features. The system transmits VAD output when available and does not depend on the availability of FE output for transmission. Both the VAD output and the FE output are synchronized with the transmission payload. Information corresponding to each segment of speech may be transmitted without frame dropping.

Channel bandwidth may be reduced during silence periods. Vector F is quantized with a lower bit rate when vector V indicates silence regions. This lower rate quantizing is similar to variable rate and multi-rate vocoders where a bit rate is changed based on voice activity detection. The system synchronizes both the VAD output and the FE output with the transmission payload. The system then transmits information corresponding to each segment of speech, thereby transmitting VAD output. The bit rate is reduced on frames with silence.

Alternately, only speech frames may be transmitted to the server. Frames with silence are dropped completely. When only speech frames are transmitted to the server, the server may attempt to conclude that the user has finished speaking. This speech completion occurs irrespective of the value of latencies k, j and n. Consider a multi-word like “Portland <PAUSE> Maine” or “617-555- <PAUSE> 1212”. The system employs a separate channel to transmit VAD information. FE features corresponding to the <PAUSE> region are dropped at the subscriber unit. As a result, the server would have no information to deduce that a user has finished speaking without a separate channel. This aspect has a separate channel for transmitting VAD information.

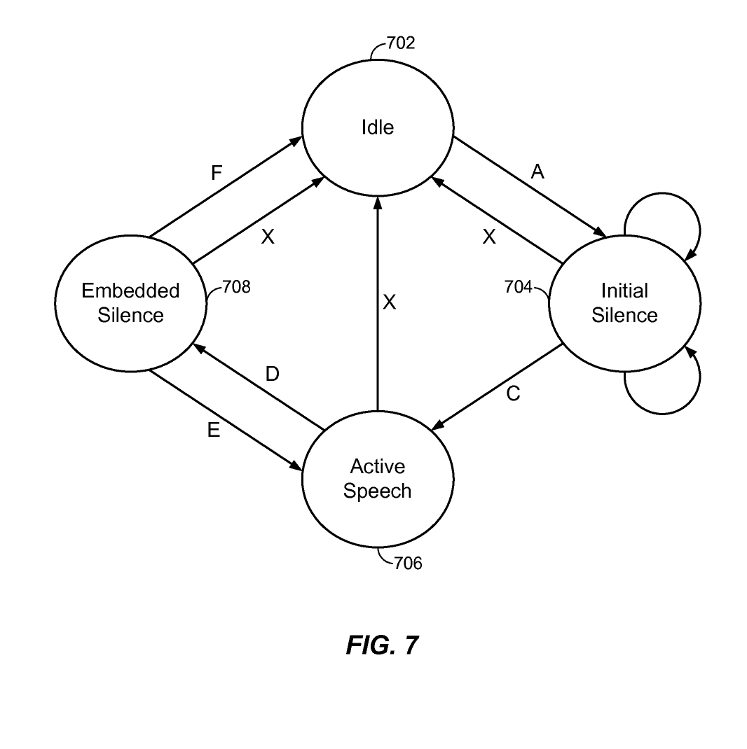

The status of a recognizer may be maintained even when there are long pauses in the user's speech as per the state diagram in FIG. 7 and the events and actions in Table 1. When the system detects speech activity, it transmits an average vector of the FE module 600 corresponding to the frames dropped and the total number of frames dropped prior to transmitting speech frames. In addition, when the terminal or mobile detects that S_{hangover} frames of silence have been observed, this signifies an end of the user's utterance. In one aspect, the speech frames and the total number of frames dropped are transmitted to the server along with the average vector of the FE module 600 on the same channel. Thus, the payload includes both features and VAD output. In one aspect, the VAD output is sent last in the payload to indicate end of speech.

For a typical utterance, the VAD module 400 will begin in Idle state 702 and transition to Initial Silence state 704 as a result of event A. A few B events may occur, leaving the module in Initial Silence state. When the system detects speech, event C causes a transition to Active Speech state 706. The module then toggles between Active Speech 706 and Embedded Silence states 708 with events D and E. When the embedded silence is longer than S_{hangover}, this constitutes an end of utterance and event F causes a transition to Idle state 702. Event Z represents a long initial silence in an utterance. This long initial silence facilitates a TIME OUT error condition when a user's speech is not detected. Event X aborts a given state and returns the module to the Idle state 702. This can be a user or a system initiated event.

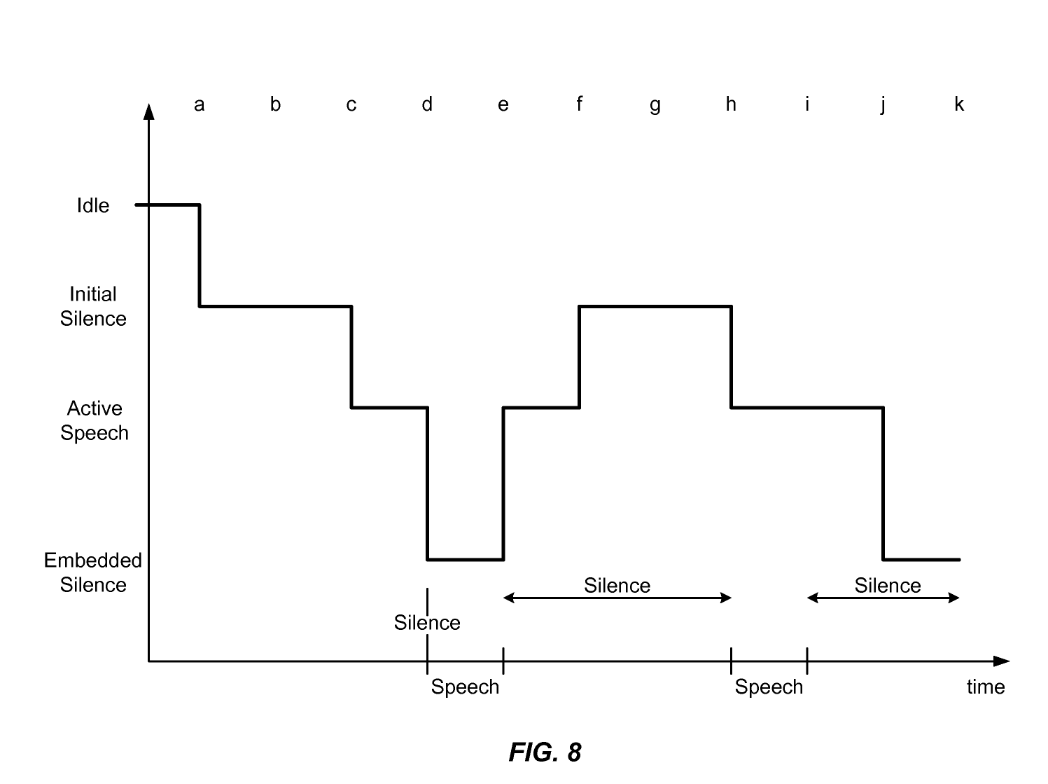

FIG. 8 shows parts of speech and VAD events on a timeline. Referring to FIG. 8 and Table 2, the events causing state transitions are shown with respect to the VAD module 400.

TABLE 1

| Event | Action |
|---|---|
| A | User initiated utterance capture. |
| B | S_{active} < Sₘᵢₙ. Active Speech duration is less than minimum utterance duration. |
| | Prevent false detection due to clicks and other extraneous noises. |
| C | S_{active} > Sₘᵢₙ. Initial speech found. Send average FE feature vector, FDcount, |
| | S_{before} frames. Start sending FE feature vectors. |
| D | Sₛᵢₗ > S_{after}. Send S_{after} frames. Reset FDcount to zero. |
| E | S_{active} > Sₘᵢₙ. Active speech found after an embedded silence. Send average FE |
| | feature vector, FDcount, S_{before} frames. Start sending FE feature vectors. |
| F | Sₛᵢₗ > S_{hangover}. End of user's speech is detected. Send average FE feature vector |
| | and FDcount. |
| X | User initiated abort. Can be user initiated from the keypad, server initiated when |
| | recognition is complete or a higher priority interrupt in the device. |
| Z | Sₛᵢₗ > MAXSILDURATION. MAXSILDURATION < 2.5 seconds for 8 bit |
| | FDCounter. Send average FE feature vector and FDcount. Reset FDcount to |
| | zero. |

In Table 1, S_{before} and S_{after} are the number of silence frames transmitted to the server before and after active speech.

From the state diagram and the table of events that show the corresponding actions on the mobile, certain thresholds are used in initiating state transitions. It is possible to use certain default values for these thresholds. However, it would be understood by those skilled in the art that other values for the thresholds shown in Table 1 may be used.

In addition, the server can modify the default values depending on the application. The default values are programmable as identified in Table 2.

TABLE 2

| Segment | Coordinates in | |
|---|---|---|
| Name | FIG. 8 | Description |
| Sₘᵢₙ | >(b-a) | Minimum Utterance Duration in frames. Used to |
| | | prevent false detection of clicks and noises as active |
| | | speech. |
| S_{active} | (e-d) and (i-h) | Duration of an active speech segment in frames, as |
| | | detected by the VAD module. |
| S_{before} | (d-c) and (h-g) | Number of frames to be transmitted before active |
| | | speech, as detected by the VAD. Amount of silence |
| | | region to be transmitted preceding active speech. |
| S_{after} | (f-e) and (j-i) | Number of frames to be transmitted after active speech, |
| | | as detected by the VAD. Amount of silence region to |
| | | be transmitted following active speech. |
| Sₛᵢₗ | (d-0), (h-e), | Duration of current silence segment in frames, as |
| | (k-i) | detected by VAD. |
| S_{embedded} | >(h-e) | Duration of silence in frames (Sₛᵢₗ) between two active |
| | | speech segments. |
| FDcount | — | Number of silence frames dropped prior to the current |
| | | active speech segment. |
| S_{hangover} | <(k-i) | Duration of silence in frames (Sₛᵢₗ) after the last active |
| | >(h-e) | speech segments for utterance capture to be complete. |
| | | S_{hangover} >= S_{embedded} |
| Sₘₐₓₛᵢₗ | | Maximum silence duration in which the mobile drops |
| | | frames. If the maximum silence duration is exceeded, |
| | | then the mobile sends an average FE feature vector and |
| | | resets the counter to zero. This is useful for keeping |
| | | the recognition state on the server active. |
| Sₘᵢₙₛᵢₗ | | Minimum silence duration expected before and after |
| | | active speech. If less than Sminsil is observed prior to |
| | | active speech, the server may decide not to perform |
| | | certain adaptation tasks using the data. This is |
| | | sometimes termed Spoke_Too_Soon error. The server |
| | | can deduce this condition from the Fdcount value and a |
| | | separate variable may not be needed. |

In one aspect, the minimum utterance duration Sₘᵢₙ is around 100 msec. In another aspect, the amount of silence region to be transmitted preceding active speech S_{before} is around 200 msec. In another aspect, S_{after}, the amount of silence to be transmitted following active speech is around 200 msec. In another aspect, the amount of silence duration following active speech for utterance capture to be complete, S_{hangover}, is between 500 msec to 1500 msec., depending on the VR application. In still another aspect, an eight bit counter enables 2.5 seconds of Sₘₐₓₛᵢₗ at 100 frames per second. In yet another aspect, minimum silence duration expected before and after active speech Sₘᵢₙₛᵢₗ is around 200 msec.

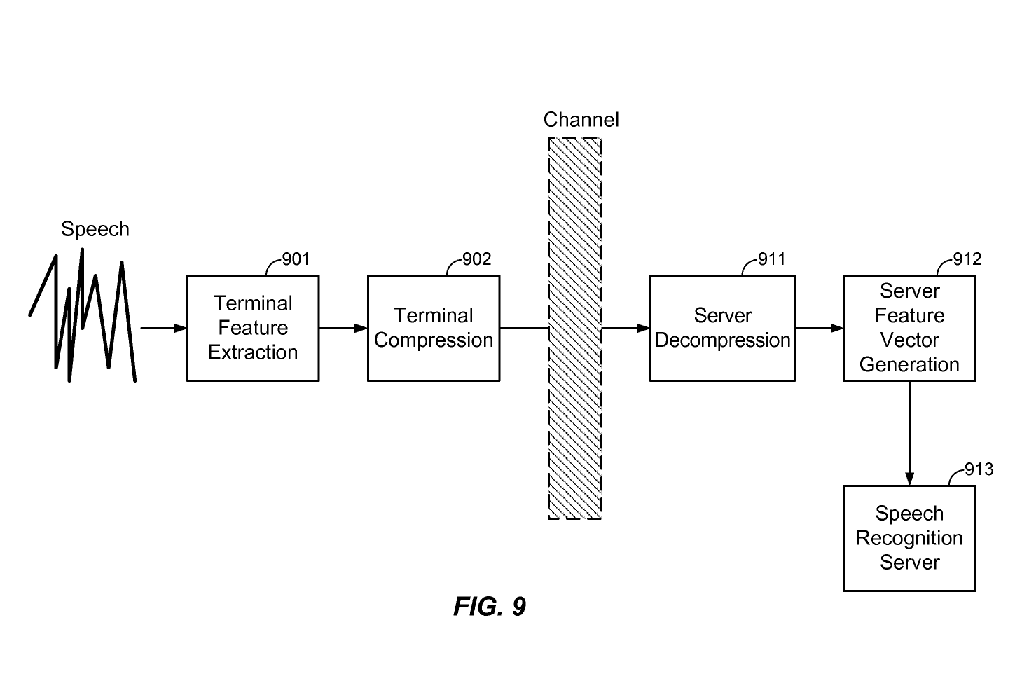

FIG. 9 shows the overall system design. Speech passes through the terminal feature extraction module 901, which operates as illustrated in FIGS. 4, 5, and 6. Terminal compression module 902 is employed to compress the features extracted, and output from the terminal compression module passes over the channel to the server. Server decompression module 911 decompresses the data and passes it to server feature vector generation module 912, which passes data to HTK module 913.

Terminal compression module 902 employs vector quantization to quantize the features. The feature vector received from the front end is quantized at the terminal compression module 902 with a split vector quantizer. Received coefficients are grouped into pairs, except C0, and each pair is quantized using its own vector quantization codebook. The resulting set of index values is used to represent the speech frame. One aspect of coefficient pairings with corresponding codebook sizes are shown in Table 3. Those of skill in the art will appreciate that other pairings and codebook sizes may be employed while still within the scope of the present invention.

TABLE 3

| | | Weight | | |
|---|---|---|---|---|
| Codebook | Size | Matrix | Elements | Bits |
| Q0-1 | 32 | I | C13-14 | 5 |
| Q2-3 | 32 | I | C11, C12 | 5 |
| Q4-5 | 32 | I | C9, C10 | 5 |
| Q6-7 | 32 | I | C7, C8 | 5 |
| Q8-9 | 32 | I | C5, C6 | 5 |
| Q10-11 | 64 | I | C3, C4 | 6 |
| Q12-13 | 128 | I | C1, C2 | 7 |
| Q14 | 64 | I | C0 | 6 |

To determine the index, the system may find the closest vector quantized (VQ) centroid using a Euclidean distance, with the weight matrix set to the identity matrix. The number of bits required for description of one frame after packing indices to the bit stream may be approximately 44. The LBG algorithm, known in the art, is used for training of the codebook. The system initializes the codebook with the mean value of all training data. In every step, the system splits each centroid into two and the two values are re-estimated. Splitting is performed in the positive and negative direction of standard deviation vector multiplied by 0.2 according to the following equations:

μᵢ⁻=μᵢ−0.2·σᵢ

μᵢ⁺=μᵢ°0.2·σᵢ

where μᵢ and σᵢ are the mean and standard deviation of the ith cluster respectively.

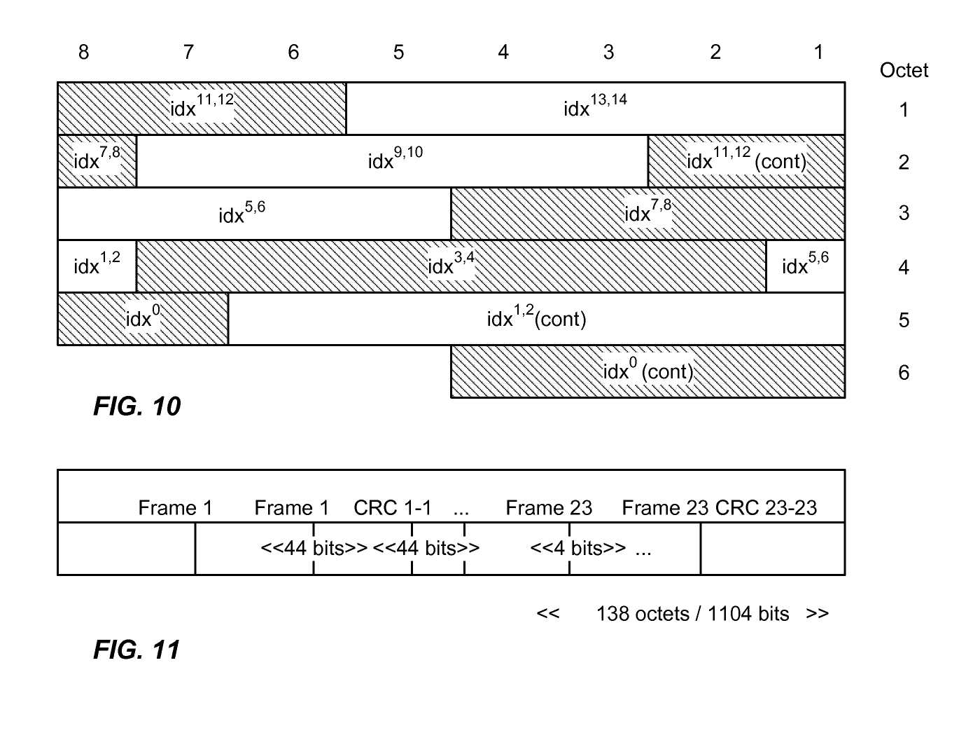

The bitstream employed to transmit the compressed feature vectors is as shown in FIG. 10. The frame structure is well known in the art and the frame with a modified frame packet stream definition. One common example of frame structure is defined in ETSI ES 201 108 v1.1.2, “Distributed Speech Recognition; Front-end Feature Extraction Algorithm; Compression Algorithm”, April 2000 (“the ETSI document”), the entirety of which is incorporated herein by reference. The ETSI document discusses the multiframe format, the synchronization sequence, and the header field. Indices for a single frame are formatted as shown in FIG. 10. Precise alignment with octet boundaries can vary from frame to frame. From FIG. 10, two frames of indices or 88 bits are grouped together as pair. The features may be downsampled, and thus the same frame is repeated as shown in FIG. 11. This frame repetition avoids delays in feature transmission. The system employs a four bit cyclic redundancy check (CRC) and combines the frame pair packets to fill the 138 octet feature stream commonly employed, such as in the ETSI document. The resulting format requires a data rate of 4800 bits/s.

On the server side, the server performs bitstream decoding and error mitigation as follows. An example of bitstream decoding, synchronization sequence detection, header decoding, and feature decompression may be found in the ETSI document. Error mitigation occurs in the present system by first detecting frames received with errors and subsequently substituting parameter values for frames received with errors. The system may use two methods to determine if a frame pair packet has been received with errors, CRC and Data Consistency. For the CRC method, an error exists when the CRC recomputed from the indices of the received frame pair packet data does not match the received CRC for the frame pair. For the Data Consistency method, the server compares parameters corresponding to each index, idx^{i, i+1} of the two frames within a frame packet pair to determine if either of the indices are received with errors according to the following equation:

$${badindexflag}_{i} = \{ \begin{matrix}1 & if ( {y}_{i} ( m + 1 ) - {y}_{i} ( m ) > 0 ) OR ( {y}_{i + 1} ( m + 1 ) - {y}_{i + 1} ( m ) > 0 ) \\ 0 & otherwise\end{matrix} \\ i = 0 , 2 , … , 13$$

The frame pair packet is classified as received with error if:

$${\sum }_{i = 0 , 2 , … 13} {badindexflag}_{i} \geq 2$$

The system may apply the Data Consistency check for errored data when the server detects frame pair packets failing the CRC test. The server may apply the Data Consistency check to the frame pair packet received before the one failing the CRC test and subsequently to frames after one failing the CRC test until one is found that passes the Data Consistency test.

After the server has determined frames with errors, it substitutes parameter values for frames received with errors, such as in the manner presented in the ETSI document.

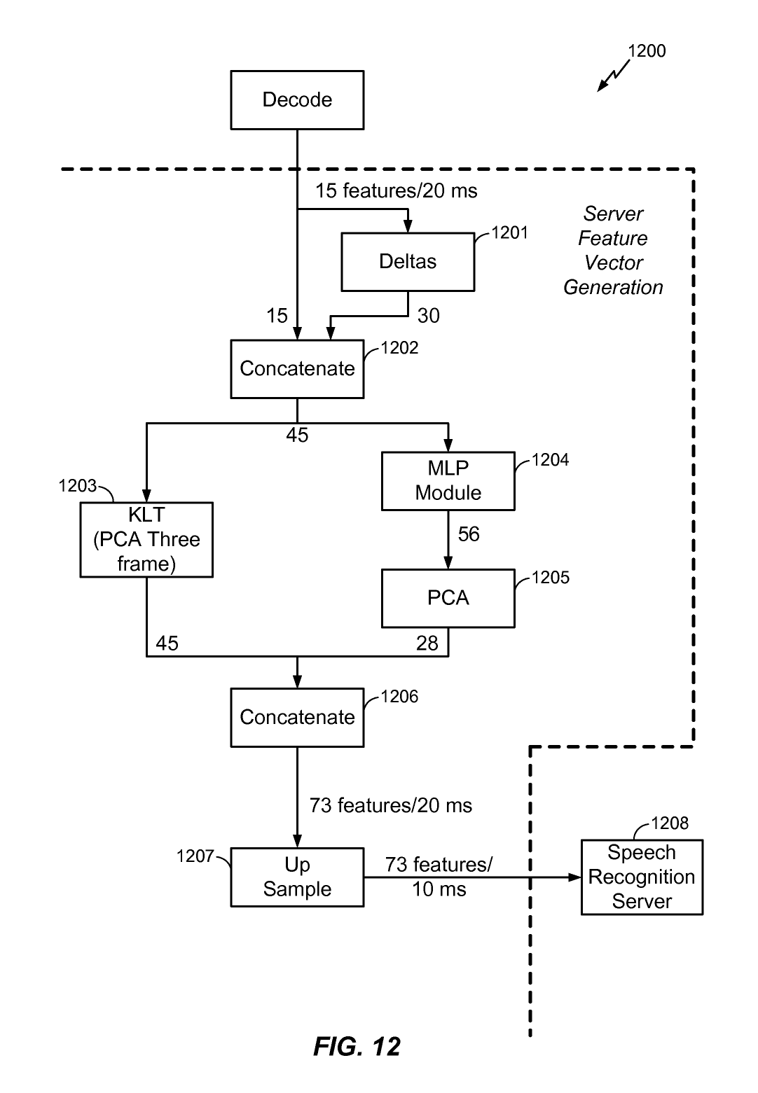

Server feature vector generation occurs according to FIG. 12. From FIG. 12, server decompression transmits 15 features in 20 milliseconds. Delta computation module 1201 computes time derivatives, or deltas. The system computes derivatives according to the following regression equation:

$${delta}_{t} = \frac{{\sum }_{l = 1}^{L} l * ( {x}_{t + l} - {x}_{t - l} )}{2 {\sum }_{l = 1}^{L} {l}^{2}}$$

where xₜ is the tₜₕ frame of the feature vector

The system computes second order derivatives by applying this equation to already calculated deltas. The system then concatenates the original 15-dimensional features by the derivative and double derivative at concatenation block 1202, yielding an augmented 45-dimensional feature vector. When calculating the first derivatives, the system may use an L of size 2, but may use an L of size 1 when calculating the double derivatives. Those of skill in the art will recognize that other parameters may be used while still within the scope of the present invention, and other calculations may be employed to compute the delta and derivatives. Use of low L sizes keeps latency relatively low, such as on the order of 40 ms, corresponding to two frames of future input.

KLT Block 1203 represents a Contextual Karhunen-Loeve Transformation (Principal Component Analysis), whereby three consecutive frames (one frame in the past plus current frame plus one frame in the future) of the 45-dimensional vector are stacked together to form a 1 by 135 vector. Prior to mean normalization, the server projects this vector using basis functions obtained through principal component analysis (PCA) on noisy training data. One example of PCA that may be employed uses a portion of the TIMIT database downsampled to 8 Khz and artificially corrupted by various types of noises at different signal to noise ratios. More precisely, the PCA takes 5040 utterances from the core training set of TIMIT and equally divides this set into 20 equal sized sets. The PCA may then add the four noises found in the Test A set of Aurora2's English digits, i.e., subway, babble, car, and exhibition, at signal to noise ratios of clean, 20, 15, 10, and 5 dB. The PCA keeps only the first 45 elements corresponding to the largest eigenvalues and employs a vector-matrix multiplication.

The server may apply a non-linear transformation to the augmented 45-dimensional feature vector, such as one using a feed-forward multilayer perceptron (MLP) in MLP module 1204. One example of an MLP is that shown in Bourlard and Morgan, “Connectionist Speech Recognition a Hybrid Approach,” Kluwer Academic Publishers, 1994, the entirety of which is incorporated herein by reference. The server stacks five consecutive feature frames together to yield a 225 dimensional input vector to the MLP. This stacking can create a delay of two frames (40 ms). The server then normalizes this 225 dimensional input vector by subtracting and dividing the global mean and the standard deviation calculated on features from a training corpus respectively. The MLP has two layers excluding the input layer; the hidden layer consists of 500 units equipped with sigmoid activation function, while the output layer consists of 56 output units equipped with softmax activation function. The MLP is trained on phonetic targets (typically 56 monophones for English) from a labeled database with added noise such as that outlined above with respect to the PCA transformation. During recognition, the server may not use the softmax function in the output units, so the output of this block corresponds to “linear outputs” of the MLP's hidden layer. The server also subtracts the average of the 56 “linear outputs” from each of the “linear outputs” according to the following equation:

$${LinOut}_{i}^{*} = {LinOut}_{i} - \frac{{\sum }_{i = 1}^{56} {LinOut}_{i}}{56}$$

$$\begin{matrix}where {LinOut}_{i} is the linear output of the ith output unit \\ and {LinOut}_{i}^{*} is the mean subtracted linear output\end{matrix}$$

The server can store each weight of the MLP in two byte words. One example of an MLP module 1204 has 225*500=112500 input to hidden weights, 500*56=28000 hidden to output weights, and 500+56=556 bias weights. The total amount of memory for this configuration required to store the weights is 141056 words. For each frame of output from the MLP module 1204, the server may have each unit in the MLP perform a multiplication of its input by its weights, an accumulation, and for the hidden layers a look-up in the table for the sigmoid function evaluation. The look-up table may have a size of 4000 two byte words. Other MLP module configurations may be employed while still within the scope of the present invention.

The server performs Dimensionality Reduction and Decorrelation using PCA in PCA block 1205. The server applies PCA to the 56-dimensional “linear output” of the MLP module 1204. This PCA application projects the features onto a space with orthogonal bases. These bases are pre-computed using PCA on the same data that is used for training the MLP as discussed above. Of the 56 features, the server may select the 28 features corresponding to the largest eigenvalues. This computation involves multiplying a 1 by 56 vector with a 56 by 28 matrix.

Second concatenation block 1206 concatenates the vectors coming from the two paths for each frame to yield to a 73-dimensional feature vector. Up sample module 1207 up samples the feature stream by two. The server uses linear interpolation between successive frames to obtain the up sampled frames. 73 features are thereby transmitted to the HTK algorithm on the server.

Thus, a novel and improved method and apparatus for voice recognition has been described. Those of skill in the art will understand that the various illustrative logical blocks, modules, and mapping described in connection with the aspects disclosed herein may be implemented as electronic hardware, computer software, or combinations of both. The various illustrative components, blocks, modules, circuits, and steps have been described generally in terms of their functionality. Whether the functionality is implemented as hardware or software depends upon the particular application and design constraints imposed on the overall system. Skilled artisans recognize the interchangeability of hardware and software under these circumstances, and how best to implement the described functionality for each particular application.

As examples, the various illustrative logical blocks, modules, and mapping described in connection with the aspects disclosed herein may be implemented or performed with a processor executing a set of firmware instructions, an application specific integrated circuit (ASIC), a field programmable gate array (FPGA) or other programmable logic device, discrete gate or transistor logic, discrete hardware components such as, e.g., registers, any conventional programmable software module and a processor, or any combination thereof designed to perform the functions described herein. The VAD module 400 and the FE module 600 may advantageously be executed in a microprocessor, but in the alternative, the VAD module 400 and the FE module 600 may be executed in any conventional processor, controller, microcontroller, or state machine. The templates could reside in RAM memory, flash memory, ROM memory, EPROM memory, EEPROM memory, registers, hard disk, a removable disk, a CD-ROM, or any other form of storage medium known in the art. The memory (not shown) may be integral to any aforementioned processor (not shown). A processor (not shown) and memory (not shown) may reside in an ASIC (not shown). The ASIC may reside in a telephone.

The previous description of the embodiments of the invention is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed is:

1. A digital voice recognition (DVR) system comprising:
a subscriber unit that receives a speech signal, wherein the subscriber unit includes:
a voice activity detection (VAD) module that detects voice activity within the speech signal and generates an indication of the detected voice activity, wherein the VAD module comprises:
a sample rate conversion module, wherein the sample rate conversion module receives processed frames of the speech signal and changes a sample rate of the processed frames of the speech signal to generate sample rate converted frames;
a transform module coupled to the sample rate conversion module that calculates cepstral coefficients of the sample rate converted frames by performing a discrete cosine transformation of the sample rate converted frames;
a probability estimator module coupled to the transform module that estimates a probability of whether a current frame of the sample rate converted frames includes speech based on one or more of the cepstral coefficients; and
a threshold module that applies a threshold to the estimated probability to convert the estimated probability to a binary feature, wherein the binary feature is the indication of voice activity;
a feature extraction (FE) module that extracts at least one speech feature from the speech signal; and
a transmitter that transmits the indication of detected voice activity and the at least one speech feature; and
a central communications center that receives the indication of detected voice activity and the at least one speech feature from the subscriber unit.

2. The system of claim 1, wherein the central communications center determines at least one linguistic estimate.

3. The system of claim 1, wherein the FE module concatenates the indication of the detected voice activity and the at least one feature.

4. The system of claim 1, wherein the transmitter transmits the indication of the detected voice activity when available.

5. The system of claim 1, wherein the subscriber unit further comprises:
a framing module that generates a plurality of frames of the speech signal;
a windowing module coupled to the framing module that windows each one of the plurality of frames;
a transform module coupled to the windowing module that computes a magnitude spectrum for each windowed frame;
a power spectrum module coupled to the transform module that computes a power spectrum of the magnitude spectrum;
a filtering module coupled to the power spectrum module that filters the power spectrum; and
a non-linear transformation module coupled to the filtering module that generates non-linear transformation of the filtered power spectrum, wherein the generated non-linear transformation is the processed frames of the speech signal,
wherein the VAD module and the FE module are coupled to the non-linear transformation module.

6. The system of claim 5, wherein the transform module computes the magnitude spectrum via a fast-Fourier transform.

7. The system of claim 5, wherein the filtering module filters the power spectrum by using a complete frequency range of a MEL-warped spectrum.

8. The system of claim 1, wherein the sample rate conversion module downsamples the processed frames of the speech signal by a factor of two.

9. The system of claim 1, wherein the VAD module further comprises a median filter coupled to the threshold module that smoothes the binary feature.

10. The system of claim 9, wherein the median filter is an 11 point median filter.

11. The system of claim 9, wherein the median filter removes short pauses or bursts of speech.

12. The system of claim 9, wherein the median filter adds seven frames before and after the current frame that is estimated to include speech.

13. The system of claim 9, wherein the median filter sets a bit according to whether the current frame is estimated to include speech.

14. The system of claim 1, wherein the probability estimator module receives the current frame, two frames adjacent to the current frame, and two cepstral coefficients calculated by the transform module.

15. A subscriber unit comprising:
a microphone that receives speech signals;
a voice activity detection (VAD) module that detects voice activity within the speech signal and generates an indication of the detected voice activity, wherein the VAD module comprises:
a sample rate conversion module, wherein the sample rate conversion module receives processed frames of the speech signal and changes a sample rate of the processed frames of the speech signal to generate sample rate converted frames;
a transform module coupled to the sample rate conversion module that calculates cepstral coefficients of the sample rate converted frames by performing a discrete cosine transformation of the sample rate converted frames;
a probability estimator module coupled to the transform module that estimates a probability of whether a current frame of the sample rate converted frames includes speech based on one or more of the cepstral coefficients; and
a threshold module that applies a threshold to the estimated probability to convert the estimated probability to a binary feature, wherein the binary feature is the indication of voice activity;
a feature extraction (FE) module that extracts at least one speech feature from the speech signal; and
a transmitter that transmits the indication of detected voice activity and the at least one speech feature.

16. The subscriber unit of claim 15, wherein the FE module concatenates the indication of the detected voice activity and the at least one feature.

17. The subscriber unit of claim 15, wherein the transmitter transmits the indication of the detected voice activity when available.

18. The subscriber unit of claim 15, further comprising:
a framing module that generates a plurality of frames of the speech signal;
a windowing module coupled to the framing module that windows each one of the plurality of frames;
a transform module coupled to the windowing module that computes a magnitude spectrum for each windowed frame;
a power spectrum module coupled to the transform module that computes a power spectrum of the magnitude spectrum;
a filtering module coupled to the power spectrum module that filters the power spectrum; and
a non-linear transformation module coupled to the filtering module that generates non-linear transformation of the filtered power spectrum, wherein the generated non-linear transformation is the processed frames of the speech signal,
wherein the VAD module and the FE module are coupled to the non-linear transformation module.

19. The subscriber unit of claim 18, wherein the transform module computes the magnitude spectrum via a fast-Fourier transform.

20. The subscriber unit of claim 18, wherein the filtering module filters the power spectrum by using a complete frequency range of a MEL-warped spectrum.

21. The subscriber unit of claim 15, wherein the sample rate conversion module downsamples the processed frames of the speech signal by a factor of two.

22. The subscriber unit of claim 15, wherein the VAD module further comprises a median filter coupled to the threshold module that smoothes the binary feature.

23. The subscriber unit of claim 22, wherein the median filter is an 11 point median filter.

24. The subscriber unit of claim 22, wherein the median filter removes short pauses or bursts of speech.

25. The subscriber unit of claim 22, wherein the median filter adds seven frames before and after the current frame that is estimated to include speech.

26. The subscriber unit of claim 22, wherein the median filter sets a bit according to whether the current frame is estimated to include speech.

27. The subscriber unit of claim 15, wherein the probability estimator module receives the current frame, two frames adjacent to the current frame, and two cepstral coefficients calculated by the transform module.

28. A voice activity detection (VAD) processor comprising:
a sample rate conversion module implemented as hardware in the VAD processor, wherein the sample rate conversion module receives processed frames of a speech signal and changes a sample rate of the processed frames of the speech signal to generate sample rate converted frames;
a transform module implemented as hardware in the VAD processor and coupled to the sample rate conversion module that calculates cepstral coefficients of the sample rate converted frames of the speech signal by performing a discrete cosine transformation of the sample rate converted frames;
a probability estimator module implemented as hardware in the VAD processor and coupled to the transform module that estimates a probability of whether a current frame of the sample rate converted frames includes speech based on one or more of the cepstral coefficients; and
a threshold module implemented as hardware in the VAD processor that applies a threshold to the estimated probability to convert the estimated probability to a binary feature, wherein the binary feature is an indication of voice activity.

29. The VAD processor of claim 28, wherein the processed frames of the speech signal are generated via:
a framing module that generates a plurality of frames of the speech signal;
a windowing module coupled to the framing module that windows each one of the plurality of frames;
a transform module coupled to the windowing module that computes a magnitude spectrum for each windowed frame;
a power spectrum module coupled to the transform module that computes a power spectrum of the magnitude spectrum;
a filtering module coupled to the power spectrum module that filters the power spectrum; and
a non-linear transformation module coupled to the filtering module that generates a non-linear transformation of the filtered power spectrum, wherein the non-linear transformation comprises the processed frames of the speech signal.

30. The VAD processor of claim 28, wherein the sample rate conversion module downsamples the processed frames of the speech signal by a factor of two.

31. The VAD processor of claim 28 further comprising a median filter coupled to the threshold module that smoothes the binary feature.

32. The VAD processor of claim 31, wherein the median filter is an 11 point median filter.

33. The VAD processor of claim 31, wherein the median filter removes short pauses or bursts of speech.

34. The VAD processor of claim 31, wherein the median filter adds seven frames before and after the current frame that is estimated to include speech.

35. The VAD processor of claim 31, wherein the median filter sets a bit according to whether the current frame is estimated to include speech.

36. The VAD processor of claim 31, wherein the probability estimator module receives the current frame, two frames adjacent to the current frame, and two cepstral coefficients calculated by the transform module.

37. A method for transmitting speech activity, comprising:
receiving, via a subscriber unit, a speech signal;
processing, via the subscriber unit, the speech signal;
detecting, via the subscriber unit, voice activity within the speech signal and generating an indication of the detected voice activity, wherein detecting voice activity within the speech signal and generating the indication of the detected voice activity comprises:
converting a sample rate of the processed speech signal to generate sample rate converted frames;
calculating cepstral coefficients of the sample rate converted frames by performing a discrete cosine transformation of the sample rate converted frames;
estimating a probability of whether a current frame of the sample rate converted frames includes speech based on one or more of the cepstral coefficients; and
applying a threshold to the estimated probability to convert the estimated probability to a binary feature, wherein the binary feature is the indication of voice activity;
extracting, via the subscriber unit, at least one feature from the speech signal; and
transmitting, via the subscriber unit, the indication of the detected voice activity and the at least one feature.

38. The method of claim 37, wherein transmitting the indication of the detected voice activity and the at least one feature comprises concatenating the indication of the detected voice activity and the at least one feature and transmitting the concatenated indication of the detected voice activity and the at least one feature.

39. The method of claim 37, wherein transmitting the indication of the detected voice activity and the at least one feature comprises transmitting the detected voice activity when available.

40. The method of claim 37, wherein processing the speech signal comprises:
generating a plurality of frames of the speech signal;
windowing each one of the plurality of frames;
computing a magnitude spectrum for each windowed frame;
computing a power spectrum for each magnitude spectrum;
filtering the power spectrum; and
generating a non-linear transformation of the filtered power spectrum.

41. The method of claim 40, wherein computing the magnitude spectrum comprises performing a fast-Fourier transform.

42. The method of claim 40, wherein filtering the power spectrum comprises filtering based on a complete frequency range of a MEL-warped spectrum.

43. The method of claim 37, wherein converting the sample rate of the processed speech signal comprises downsampling the processed speech signal by a factor of 2.

44. The method of claim 37, further comprising:
smoothing the binary feature to generate the indication of voice activity.

45. The method of claim 37, further comprising:
setting a bit according to whether the current frame is estimated to include speech, wherein the bit is the indication of voice activity.

46. A method for detecting voice activity, comprising:
processing, via a voice activity detection (VAD) processor, a speech signal to generate processed frames;
converting, via the VAD processor, a sample rate of the processed frames of the speech signal to generate sample rate converted frames;
calculating, via the VAD processor, cepstral coefficients of the sample rate converted frames by performing a discrete cosine transformation of the sample rate converted frames;
estimating, via the VAD processor, a probability of whether a current frame of the sample rate converted frames includes speech based on one or more of the cepstral coefficients; and
applying, via the VAD processor, a threshold to the estimated probability to convert the estimated probability to a binary feature, wherein the binary feature is an indication of voice activity.

47. The method of claim 46, wherein processing the speech signal to generate processed frames comprises:
generating a plurality of frames of the speech signal;
windowing each one of the plurality of frames;
computing a magnitude spectrum for each windowed frame;
computing a power spectrum for each magnitude spectrum;
filtering the power spectrum; and
generating a non-linear transformation of the filtered power spectrum.

48. The method of claim 46, wherein converting a sample rate of the processed speech signal comprises downsampling the processed speech signal by a factor of 2.

49. The method of claim 46, further comprising:
smoothing the binary feature to generate the indication of voice activity.

50. The method of claim 46, further comprising:
setting a bit according to whether the current frame is estimated to include speech, wherein the bit is the indication of voice activity.

51. A computer-readable storage medium comprising one or more memories that store instructions that cause one or more processors to:
receive a speech signal;
process the speech signal;
detect voice activity within the speech signal and generate an indication of the
detected voice activity, wherein instruction that cause the one or more processors to detect voice activity within the speech signal and generate the indication of the detected voice activity comprises instructions that cause the one or more processors to:
convert a sample rate of the processed speech signal to generate sample rate converted frames;
calculate cepstral coefficients of the sample rate converted frames by performing a discrete cosine transformation of the sample rate converted frames;
estimate a probability of whether a current frame of the sample rate converted frames includes speech based on one or more of the cepstral coefficients; and
apply a threshold to the estimated probability to convert the estimated probability to a binary feature, wherein the binary feature is the indication of voice activity;
extract at least one feature from the speech signal; and
transmit the indication of the detected voice activity and the at least one feature.

52. The computer-readable storage medium of claim 51, wherein instructions that cause one or more processors to transmit the indication of the detected voice activity and the at least one feature comprises instructions that cause one or more processors to concatenate the indication of the detected voice activity and the at least one feature and transmit the concatenated indication of the detected voice activity and the at least one feature.

53. The computer-readable storage medium of claim 51, wherein instructions that cause one or more processors to transmit the indication of the detected voice activity and the at least one feature comprises instructions that cause one or more processors to transmit the detected voice activity when available.

54. The computer-readable storage medium of claim 51, wherein the instructions that cause the one or more processors to process the speech signal comprises:
instructions that cause the one or more processors to generate a plurality of frames of the speech signal;
instructions that cause the one or more processors to window each one of the plurality of frames;
instructions that cause the one or more processors to compute a magnitude spectrum for each windowed frame;
instructions that cause the one or more processors to compute a power spectrum for each magnitude spectrum;
instructions that cause the one or more processors to filter the power spectrum; and
instructions that cause the one or more processors to generate a non-linear transformation of the filtered power spectrum.

55. The computer-readable storage medium of claim 54, wherein the instructions that cause the one or more processors to compute the magnitude spectrum comprise instructions that cause the one or more processors to perform a fast-Fourier transform.

56. The computer-readable storage medium of claim 54, wherein the instructions that cause the one or more processors to filter the power spectrum comprise instructions that cause the one or more processors to filter based on a complete frequency range of a MEL-warped spectrum.

57. The computer-readable storage medium of claim 51, wherein the instructions that cause the one or more processors to convert the sample rate the processed speech signal comprise instructions that cause the one or more processors to downsample the processed speech signal by a factor of 2.

58. The computer-readable storage medium of claim 51, further comprising:
instructions that cause the one or more processors to smooth the binary feature to generate the indication of voice activity.

59. The computer-readable storage medium of claim 51, further comprising:
instructions that cause the one or more processors to set a bit according to whether a current frame is determined to include speech, wherein the bit is the indication of voice activity.

60. A computer-readable storage medium comprising one or more memories that store instructions that cause one or more processors to:
process a speech signal to generate processed frames;
convert a sample rate of processed frames of the speech signal to generate sample rate converted frames;
calculate cepstral coefficients of the sample rate converted frames by performing a discrete cosine transformation of the sample rate converted frames;
estimate a probability of whether a current frame of the sample rate converted frames includes speech based on one or more of the cepstral coefficients; and
apply a threshold to the estimated probability to convert the estimated probability to a binary feature, wherein the binary feature is an indication of voice activity.

61. The computer-readable storage medium of claim 60, wherein the instructions that cause one or more processors to process the speech signal to generate processed frames comprise:
instructions that cause the one or more processors to generate a plurality of frames of the speech signal;
instructions that cause the one or more processors to window each one of the plurality of frames;
instructions that cause the one or more processors to compute a magnitude spectrum for each windowed frame;
instructions that cause the one or more processors to compute a power spectrum for each magnitude spectrum;
instructions that cause the one or more processors to filter the power spectrum; and
instructions that cause the one or more processors to generate a non-linear transformation of the filtered power spectrum.

62. The computer-readable storage medium of claim 60, wherein the instructions that cause the one or more processors to convert the sample rate of processed frames comprise instructions that cause the one or more processors to downsample the processed frames by a factor of 2.

63. The computer-readable storage medium of 60, further comprising:
instructions that cause the one or more processors to smooth the binary feature to generate the indication of voice activity.

64. The computer-readable storage medium of claim 60, further comprising:
instructions that cause the one or more processors to set a bit according to whether the current frame is estimated to include speech, wherein the bit is the indication of voice activity.

65. A digital voice recognition (DVR) system comprising:
means for receiving a speech signal, wherein the means for receiving includes:
means for detecting voice activity within the speech signal and generating an indication of the detected voice activity, wherein the means for detecting voice activity within the speech signal and generating the indication of the detected voice activity comprises:
means for processing the speech signal;
means for converting a sample rate of the processed speech signal to generate sample rate converted frames;
means for calculating cepstral coefficients of the sample rate converted frames by performing a discrete cosine transformation of the sample rate converted frames;
means for estimating a probability of whether a current frame of the sample rate converted frames includes speech based on one or more of the cepstral coefficients; and
means for applying a threshold to the estimated probability to convert the estimated probability to a binary feature, wherein the binary feature is the indication of voice activity;
means for extracting at least one speech feature from the speech signal; and
means for transmitting the indication of detected voice activity and the at least one speech feature; and
means for receiving the indication of detected voice activity and the at least one speech feature from the subscriber unit.

66. The DVR system of claim 65, further comprising means for determining at least one linguistic estimate of speech from the at least one speech feature.

67. The DVR system of claim 65, wherein the means for extracting concatenates the indication of the detected voice activity and the at least one feature.

68. The DVR system of claim 65, wherein the means for transmitting transmits the indication of the detected voice activity when available.

69. The DVR system of claim 65, wherein the means for processing comprises:
means for generating a plurality of frames of the speech signal;
means for windowing each one of the plurality of frames;
means for computing a magnitude spectrum for each windowed frame;
means for computing a power spectrum of the magnitude spectrum;
means for filtering the power spectrum; and
means for generating non-linear transformation of the filtered power spectrum.

70. The DVR system of claim 69, wherein the means for computing the magnitude spectrum comprises means for performing a fast-Fourier transform.

71. The DVR system of claim 70, wherein the means for filtering the power spectrum comprises means for filtering by using a complete frequency range of a MEL warped-spectrum.

72. The DVR system of claim 65, wherein the means for converting the sample rate downsamples the processed speech signal by a factor of two.

73. The DVR system of claim 65, wherein means for detecting voice activity within the speech signal and generating an indication of the detected voice activity further comprises:
means for smoothing the binary feature.

74. The DVR system of claim 73, wherein the means for smoothing adds seven frames before and after the current frame that is estimated to include speech.

75. The DVR system of claim 73, wherein the means for smoothing comprises means for setting a bit according to whether the current frame is estimated to include speech.

76. The DVR system of claim 65, wherein the means for estimating receives the current frame, two adjacent frames, and two cepstral coefficients calculated by the means for calculating.

77. A subscriber unit comprising:
means for receiving speech signals;
means for detecting voice activity within the speech signal and generating an indication of the detected voice activity, wherein the means for detecting voice activity within the speech signal and generating the indication of the detected voice activity comprises:
means for processing the speech signal;
means for converting a sample rate of the processed speech signal to generate sample rate converted frames;
means for calculating cepstral coefficients of the sample rate converted frames by performing a discrete cosine transformation of the sample rate converted frames;
means for estimating a probability of whether a current frame of the sample rate converted frames includes speech based on one or more of the cepstral coefficients; and
means for applying a threshold to the estimated probability to convert the estimated probability to a binary feature, wherein the binary feature is the indication of voice activity;
means for extracting at least one speech feature from the speech signal; and
means for transmitting the indication of detected voice activity and the at least one speech feature.

78. The subscriber unit of claim 77, wherein the means for extracting concatenates the indication of the detected voice activity and the at least one feature.

79. The subscriber unit of claim 77, wherein the means for transmitting transmits the indication of the detected voice activity when available.

80. The subscriber unit of claim 77,wherein the means for processing comprises:
means for generating a plurality of frames of the speech signal;
means for windowing each one of the plurality of frames;
means for computing a magnitude spectrum for each windowed frame;
means for computing a power spectrum of the magnitude spectrum;
means for filtering the power spectrum; and
means for generating non-linear transformation of the filtered power spectrum.

81. The subscriber unit of claim 80, wherein the means for computing the magnitude spectrum comprises means for performing a fast-Fourier transform.

82. The subscriber unit of claim 80, wherein the means for filtering the power spectrum comprises means for filtering by using a complete frequency range of a MEL warped-spectrum.

83. The subscriber unit of claim 77, wherein the means for converting the sample rate downsamples the processed speech signal by a factor of two.

84. The subscriber unit of claim 77, wherein means for detecting voice activity within the speech signal and generating an indication of the detected voice activity further comprises:
means for smoothing the binary feature.

85. The subscriber unit of claim 84, wherein the means for smoothing adds seven frames before and after the current frame that is estimated to include speech.

86. The subscriber unit of claim 84, wherein the means for smoothing comprises means for setting a bit according to whether the current frame is determined to include speech.

87. The subscriber unit of claim 77, wherein the means for estimating receives the current frame, two adjacent frames, and two cepstral coefficients calculated by the means for calculating.

88. A voice activity detection (VAD) processor comprising:
means for converting a sample rate of received processed frames of a speech signal to generate sample rate converted frames, wherein the means for converting is implemented as hardware within the VAD processor;
means for calculating cepstral coefficients of the sample rate converted frames by performing a discrete cosine transformation of the sample rate converted frames, wherein the means for calculating is implemented as hardware within the VAD processor;
means for estimating a probability of whether a current frame of the sample rate converted frames includes speech based on one or more of the cepstral coefficients, wherein the means for estimating is implemented as hardware within the VAD processor; and
means for applying a threshold to the estimated probability to convert the estimated probability to a binary feature, wherein the binary feature is an indication of voice activity, wherein the means for applying is implemented as hardware within the VAD processor.

89. The VAD processor of claim 88, wherein the processed frames of the speech signal are generated via:
means for generating a plurality of frames of the speech signal;
means for windowing each one of the plurality of frames;
means for computing a magnitude spectrum for each windowed frame;
means for computing a power spectrum of the magnitude spectrum;
means for filtering the power spectrum; and
means for generating non-linear transformation of the filtered power spectrum, wherein the generated non-linear transformation is the processed frames of the speech signal.

90. The VAD processor of claim 88, wherein the means for converting the sample rate downsamples the processed frames by a factor of two.

91. The VAD processor of claim 88, further comprising:
means for smoothing the binary feature.

92. The VAD processor of claim 91, wherein the means for smoothing adds seven frames before and after current frame that is estimated to include speech.

93. The VAD processor of claim 91, wherein the means for smoothing comprises means for setting a bit according to whether current frame is estimated to include speech.

94. The VAD processor of claim 88, wherein the means for estimating receives the current frame, two adjacent frames, and two cepstral coefficients calculated by the means for calculating.

95. The DVR system of claim 1, wherein the transmitter transmits the indication of the detected voice activity from the VAD module before the at least one speech feature extracted by the FE module.

96. The subscriber unit of claim 15, wherein the transmitter transmits the indication of the detected voice activity from the VAD module before the at least one speech feature extracted by the FE module.

97. The method of claim 37, wherein transmitting the indication of the detected voice activity and the at least one feature comprises transmitting the indication of the detected voice activity before transmitting the at least one feature.

98. The computer-readable storage medium of claim 51, wherein the instructions that cause the one or more processors to transmit the indication of the detected voice activity and the at least one feature comprise instructions that cause the one or more processors to transmit the indication of the detected voice activity before transmission of the at least one feature.

99. The DVR system of claim 65, wherein the means for transmitting the indication of detected voice activity and the at least one speech feature comprises means for transmitting the indication of detected voice activity before transmitting the at least one speech feature.

100. The subscriber unit of claim 77, wherein the means for transmitting the indication of detected voice activity and the at least one speech feature comprises means for transmitting the indication of detected voice activity before transmitting the at least one speech feature.
